(19) United States
(12) Patent Application Publication
(10) Pub. No.: US 2006/0061054 A1
(43) Pub. Date: Mar. 23, 2006

(54) Skateboard assembly with shock absorbing suspension system

(76) Inventor: Richard D. Grossman, Granada Hills, CA (US)

Correspondence Address: FULWIDER PATTON, 6060 CENTER DRIVE, 10TH FLOOR, LOS ANGELES, CA, 90045, US

(21) Appl. No.: 10/263,362

(22) Filed: Oct. 1, 2002

(51) Int. Cl. B62M 1/00

(52) U.S. Cl. 280/87.042

(57) ABSTRACT

A skateboard assembly includes a platform or board, a plurality of spaced wheel axles and pivotally secured set of arms connected to the frame at opposite ends of the skateboard. The truck suspension system provides shock-absorbing capabilities and includes an improved shock-absorbing system that can be easily interchanged to create a desired amount of shock-absorbing capability for the skateboard. The shock-absorbing system includes an outer shock member which encases at least one shock-absorbing insert. These shock-absorbing components are placed between each arm of the truck assembly and the board to absorb shock. The shock-absorbing insert is interchangeable so that the amount of shock absorption can be changed depending upon the rider's weight or to attain a particular ride feel. A quick release strap-down system utilizes hook and loop fasteners to create a system for easily and quickly interchanging the shock-absorbing components. A steering control system includes a resilient dampener which is adjustable to restrict the steering rotation of the wheel axles to provide shock absorption for the truck suspension system.

### BACKGROUND OF THE INVENTION

The present invention relates generally to skateboards and, more particularly, to a skateborad having a novel suspension system with improved shock absorbing components and exceptional steering control.

Skateboards have been very popular for a number of years and generally include an elongated board or platform having a set of wheels mounted at opposite ends. Normally, the rider of a skateboard stands on the platform with one foot and propels himself with the other while maintaining proper balance to avoid falling from the skateboard. A rider can guide the skateboard in different directions and perform a number of maneuvers by properly shifting body weight or foot placement on the board. Generally, a considerable amount of skill is needed to properly ride a skateboard as the rider must maintain proper balance while controlling the speed and direction of the board. Since skateboarders can achieve considerable speeds, there is an increased need for the rider to properly control and stop the board, when necessary, to avoid collisions with other skateboarders, vehicles or stationary structures. Additionally, skateboarders often ride over rough terrain or surfaces which can cause the transmission of considerable shock and vibration through the wheels, axles and trucks to the skateboarder. When skateboarders reach a level of superior skill, many intricate high speed maneuvers can be performed which require fine balance and timing. However, the transmission of heavy vibrations and shock to the skateboarder can seriously interfere with the skateboarder's ability to execute high speed maneuvers as well as diminish the overall enjoyment of the sport. Additionally, the transmission of unwanted vibrations and shock from the skateboard to the rider can affect the rider's ability to safely maneuver the skateboard.

Accordingly, there has been a need for an improved skateboard which provides a smoother ride than today's conventional skateboard, yet is light weight and durable enough to allow the rider to perform flip tricks as well as jumping maneuvers. Additionally, a smoother ride with enhanced safety is always desirous to the rider. Such a skateboard would be beneficial if it provides improved shock-absorbing functions, yet remains ultrastiff for superior handling. Moreover, the shock-absorbing system of the skateboard should be ultra-light so as not to diminish the rider's ability to perform intricate high-speed maneuvers. Preferably, the shock-absorbing components of the skateboard should be easily adjustable to compensate for differing body weights and should permit quick and easy fine tuning of its balance and steering functions in order to obtain optimum performance. The present invention satisfies these and other needs.

### SUMMARY OF THE INVENTION

The present invention provides an improved skateboard assembly which provides an improved and easily changeable shock absorbing system while remaining ultrastiff for superior handling and performance. The skateboard assembly includes an elongated platform or board attached to a truck suspension system which by itself provides superior shock-absorbing capabilities, yet is extremely strong, durable and maintains high rigidity for superior handling. The truck suspension system includes a steering control system that can be easily fine-tuned for a particular rider. Additionally, the truck suspension system includes a suspension offering an adjustable shock-absorbing system that can be quickly and easily adjusted to provide increased or decreased shock stiffness for a given body weight or for a particular riding style. This shock-absorbing system also can be preloaded, if desired, to provide either increased or decreased shock stiffness to the skateboard.

The skateboard truck system of the present invention utilizes a pair of arms connected to the underside of the board. Each of the arms includes a wheel axle housing located near one end. Each arm can be pivotally connected at its other end to a housing mounted on the underside of the board. Materials which can be used to form the arms include urethane-based composites with long glass fibers that provide high strength, yet is light weight. Alternative materials include lightweight metals such as aluminum and magnesium. The arms and the material forming the arms enhance the dampening and shock-absorbing characteristics for the overall suspension system. In one aspect of the present invention, each arm has a substantially A-shape construction which provides added stability to the truck suspension system.

The truck suspension system includes a quick change shock-absorbing system coupled to the underside of the board. The shock-absorbing system provides improved shock absorbability and is easily changeable to compensate for the riders' weight and/or riding style. The shock-absorbing system is attached to each arm and the underside of the board. In one particular aspect of the present invention, the shock-absorbing system utilizes a novel shock insert system that allows the rider to quickly and easily change the shock absorbing characteristics needed for a particular skateboarder, without the need for tools. The shock insert system includes an outer shock member, made for example, from a closed cell foam material having a recess or multiple recesses for receiving a shock-absorbing insert. The shock-absorbing insert is made from a material having good shock-absorbing characteristics, such as urethane, or other rubber based materials and is designed to fit within a recess formed in the outer shock member to fine tune the shock-absorbing features of the skateboard. The shock-absorbing insert is easily interchangeable with other inserts to create different shock-absorbing characteristics for the skateboard.

The shock-absorbing system can be used in accordance with a quick release strap-down system made, for example, from hook and loop components, to provide a quick and easy means for changing the shock-absorbing components. This same strap-down system also can be used to apply a preload force to the shock-absorbing system. As a result, the rider can quickly and easily adjust the shock-absorbing characteristics of the board prior to use.

Each arm of the truck suspension system includes an axle housing for receiving a precision manufactured axle that fits with an elongated opening extending through the wheel axle housing. A steering control system fits within the elongated opening of the axle housing and includes a steering control dampener designed to fit in the axle housing to tune the steering characteristics of the skateboard for different weight categories. The steering dampener also can provide both shock absorbing capabilities and dampening to the skateboard, especially when turning. The extent of the dampening and shock absorbing characteristics can be controlled by adjusting the longitudinal compression on the steering control dampener and/or by changing the particular material used to create the dampener. Fine tuning of the steering control system can be performed by simply tightening or loosening a bolt of a specialized fastener system associated with the dampener to control the steering arc of the wheel axle. In this regard, the amount of the dampening and shock absorption applied by the steering control dampener to the wheel axle can be easily adjusted to obtain the desired steering characteristics for the skateboard.

The present invention is primarily directed to many novel improvements made to my earlier skateboard design which is disclosed in U.S. Pat. No. 4,645,223, issued Feb. 24, 1987, which is herein incorporated by reference in its entirety.

These and other advantages of the present invention will become more apparent from the following detailed description of the invention, when taken in conjunction with the accompanying exemplary drawings.

### BRIEF DESCRIPTION OF THE DRAWINGS

FIG. 1 is a side elevational view of an embodiment of the skateboard assembly embodying features of the present invention.

FIG. 2 is a perspective view of one of the A-shaped arms and the shock-absorbing system in a raised position above the board.

FIG. 3 is a perspective view showing the shock-absorbing system of the present invention.

FIG. 4 is a cross-sectional view, partially fragmented, of the shock-absorbing system attached to one of the arms of the truck suspension system.

FIG. 5 is a cross-sectional view of the arm housing which pivotally attaches the arms to the board.

FIG. 6 is a is a cross-sectional view, partially fragmented, of the axle wheel housing and shock-absorbing system.

FIG. 7 is a cross-sectional view of the steering control dampener which is placed in the axle wheel housing to control the steering arc of the wheel axle to provide steering control.

FIG. 8 is a side elevational view showing a preload force being applied to the shock-absorbing system prior to use.

FIG. 9 is a side elevational view showing the skateboard truck system in a stored position.

### DETAILED DESCRIPTION OF THE PREFERRED EMBODIMENTS

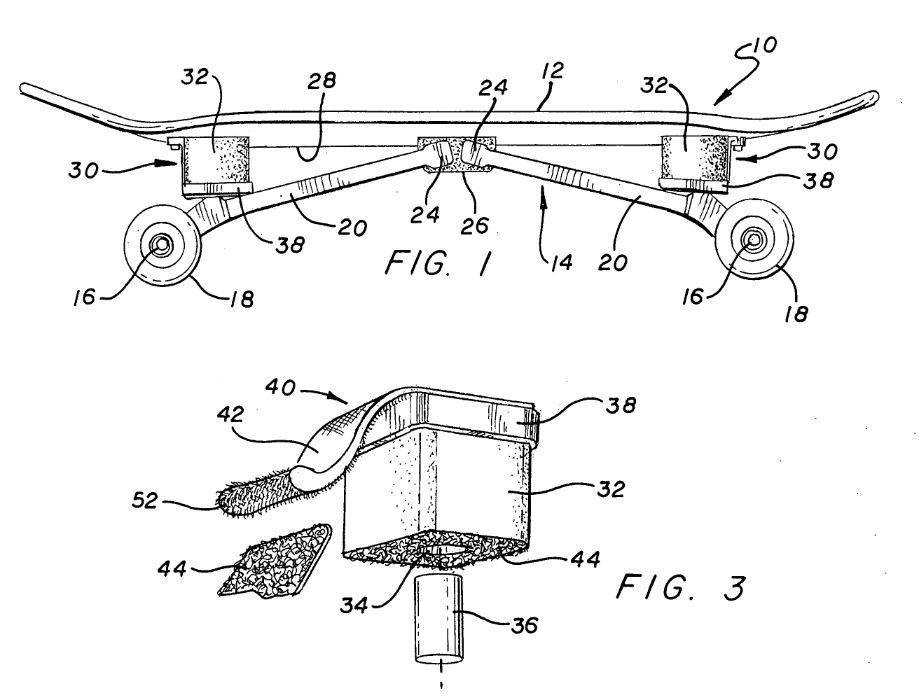

Turning now to the drawings, in which reference numerals represent like or corresponding elements in the drawings, FIG. 1 illustrates a depiction of one embodiment of a skateboard assembly 10 incorporating features of the present invention. In the particular embodiment shown in FIG. 1, the skateboard 10 includes an elongated platform or board 12 attached to a truck suspension system 14. The elongated board 12 supports the rider during use and can be formed in any number of different sizes and shapes. The base 12 can be made from a number of different materials including wood, metal, plastic, hard rubber and the like.

The truck suspension system 14 includes a pair of spaced transversely extending wheel axles 16 having bearing wheels 18 attached at the outer ends. Each wheel axle 16 is connected at the apex of a generally A-shaped arm 20 which forms part of the truck suspension system 14. Each of the generally A-shaped arms 20 includes an axle housing 22 in which the wheel axle 16 is secured. The axle housing 22 is generally located near the apex of the A-shaped arm 20. Each base 24 of the A-shaped arm 20 is pivotally connected to an arm housing 26 which is mounted at a generally central location to the underside 28 of the board 12. The wheel axle can be made from aluminum or other lightweight material which is rugged and durable. Also, it should be appreciated that although the truck suspension system 14 is shown with a pair of arms that are generally A-shaped, it is possible to use any one of a number of different shapes to create a pivotally-mounted suspension system. For example, the middle support forming the A-shape could be removed to create a triangular-type arm. However, the A-shaped structure provides superior strength to the truck suspension assembly as well as enhanced shock-absorbing capability.

Each arm can be made from a high performance composite material which helps to absorb vibrations while still being ultrastiff for superior handling. One such material is a plastic composite which is urethane based and includes long glass fibers to provide high strength. Such material is manufactured under the trademark Celstran® by Ticona Polymers. Other plastic composites which are lightweight and durable could be utilized to form the arms of the truck suspension system. It should be appreciated that metals, such as aluminum, magnesium, or other lightweight structural materials also could be utilized to form the arms of the truck suspension system. However, these alternative components may not possess as good shock-absorbing characteristics as the Celstran® material mentioned above. A molded urethane bumper 21 can be placed near the apex of the A-shaped arm to further protect against hard impacts and possible abrasion to the arm. A larger A-shaped arm cover can also be used (not shown).

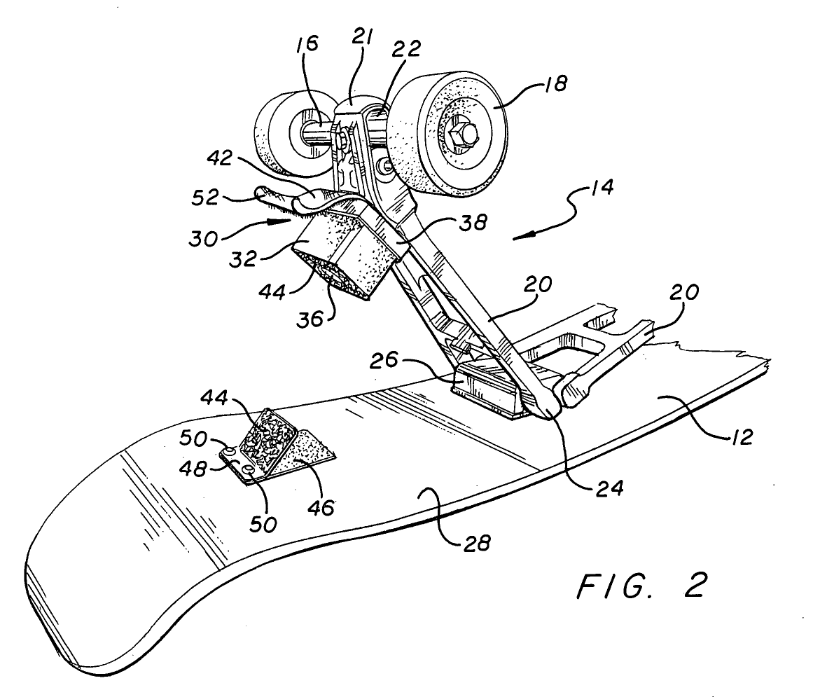

FIG. 2 shows one of the A-shaped arms 20 of the truck suspension system 14 in a raised position above the board 12. Each A-shaped arm 20 is pivotally connected to the arm housing 26 which is mounted to the underside 28 of the board 12. In this manner, the apex of the A-shaped arm can be moved away from the board in order to change the novel shock-absorbing system made in accordance with the present invention. Referring specifically now to FIGS. 2 and 3, the shock-absorbing system 30 utilized in conjunction with the truck suspension system 14 consists of shock-absorbing components that can be quickly and easily changed by the user prior to use. The shock-absorbing system 30 includes an outer shock member 32 which can be made, for example, from a closed cell foam material, such as EVA foam, that by itself provides good shock-absorbing capability. This outer shock member 32 includes at least one recess 34 adapted to receive a shock-absorbing insert 36. This shock-absorbing insert 36 can be made from a shock-absorbing material, such as urethane, and is designed to fit within the recess formed within the outer shock member 32. This shock-absorbing insert 36 provides additional shock-absorbing and dampening characteristics which cooperates with the outer shock member 32 to provide the necessary dampening and shock-absorbing capabilities for the skateboard. Since the shock-absorbing insert 36 can be easily removed from the recess 34 formed in the outer shock member 32, the rider can be supplied with a number of different shock-absorbing inserts having different shock-absorbing and dampening characteristics to allow the rider to interchange the inserts to adjust for a particular weight of a rider or to achieve a certain “ride feel”. Therefore, the amount of stiffness and shock-absorbing capability of the skateboard can be easily interchanged by the rider prior to riding the skateboard. It should also be appreciated that the outer shock member 32 can be used alone for lighter weight riders.

The shock-absorbing system 30 is shown with an outer shock member 32 that is substantially square in shape with the shock-absorbing inserts 36 being shown as substantially cylindrical in shape. However, it should be appreciated that the outer shock-absorbing member 32 and the inner shock-absorbing insert 36 can take on any number of different sizes and shapes without departing from the spirit and scope of the present invention. Although one recess 34 and a single shock-absorbing insert 36 is shown in this particular embodiment, it should also be appreciated that more than one recess can be formed in the outer shock member 32 to house multiple shock-absorbing inserts 36. Moreover, the particular materials utilized to form the outer shock member 32 and the shock-absorbing insert 36 can be modified without departing from the spirit of the present invention. Additionally, the dimensions of the outer shock member 32 and the insert 36 also can be varied as needed to achieve the desired dampening and shock-absorbing characteristics for the board.

The shock-absorbing system 30 is shown as it is attached to a shock cup 38 mounted near the apex of the A-shaped arm 20. The shock cup 38 can take on the particular shape of the outer shock member 32 in order to provide a tight snug fit once the outer shock member 32 is inserted into the shock cup 38. The shock cup 38 can be attached via a fastener, such a screw or bolt 50 into the A-shaped arm 20. The shock cup 38 can be made from high-strength polycarbonate or other similar material. The shock cup 38 will help to absorb some of the shock which may be imparted on the skateboard as it is being ridden.

A strap-down system 40, shown in greater detail in FIG. 2, is utilized to maintain the shock-absorbing system 30 and the arm 20 of the truck suspension system 14 attached to the underside 28 of the board 12. This strap-down system 40 utilizes a number of hook and loop components which provide a means for quickly and easily attaching or removing the arm 20 from the board 12. As is shown in FIG. 2, a loop strap 42 is attached to the shock cup 38 and is designed to engage a hook strap 44 affixed to the underside 28 of the board 12. Additionally, a second hook strap 46 can be permanently attached to the underside 28 of the board 12 utilizing adhesives or other bonding techniques well-known the art. A holding plate 48 is utilized to securely attach the hook strap 44 to the board 12 utilizing fasteners 50, such a screws or nuts and bolts. As can be further seen in FIG. 2, the underside of the outer shock member 32 may include a loop strap 42 affixed thereto which engages the hook strap 46 affixed to the underside of the board. It should be appreciated that the bottom of the shock cup 38 could include a hook and loop component which can attach to a hook and loop component attached to the other side of the outer shock member 32. In this manner, once the A-shaped arm 20 is moved towards the board 12, the various hook and loop components will engage to hold the various components together. In this fashion, the arms of the truck system should remain attached to the board until an appreciable force is utilized to separate the hook and loop components used to create the strap-down system.

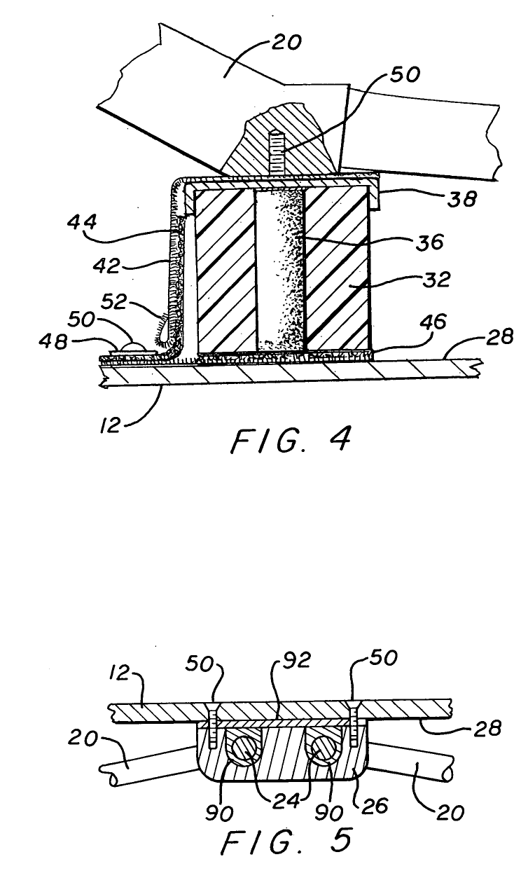

FIG. 4 further shows a cross-sectional view of the various components forming the strap-down system 40 in a secured position. As can be seen in FIG. 4, the loop strap 42 is designed to connect with the hook strap 44 attached to the underside of the board 12. The loop strap 42 may include a reinforced edge 52 which provides an easily graspable component that the rider can grip to detach the hook and loop straps. This reinforced edge 52 is easily graspable when a preload force is to be applied to the shock-absorbing system 30. The use of hook and loop components provide the rider with the ability to quickly and easily change the shock-absorbing system when necessary without the need for tools. Also, the strap-down system 40 allows for the application of an adjustable preload force on the shock-absorbing system, as will be described below. This unique strap-down system 40 also allows the arm of the truck suspension system to break away from the board in the event, for example, that a runaway skateboard impacts a solid object. Thus, this strap-down system may help to reduce possible damage to board components during unwanted fixed obstruction impacts.

Referring now to FIG. 8, the strap-down system 40 is shown as it maintains the shock-absorbing system 30 in a preloaded condition. As can be seen in FIG. 8, an arrow indicates that a preload force has been applied to the A-shaped arm 20 in order to compress the shock-absorbing system 30 somewhat to change the dampening and shock-absorbing characteristics of the shock-absorbing system 30. In FIG. 8, the outer shock member 32 is shown somewhat compressed due to the preload force that is initially applied to the shock-absorbing system. The strap-down system 40 maintains the preload force on the shock-absorbing system. In this regard, the rider simply has to apply a downward force, as is indicated by the arrow, while placing the loop strap 42 in contact with the hook strap 44 attached to the board. In this fashion, the strap-down system 40 maintains the preload force on the outer shock member 32 and the shock-absorbing insert 36 to somewhat stiffen the dampening and shock-absorbing characteristics of these components. It should be appreciated that a preload force does not necessarily have to be placed on the shock-absorbing system, as is shown in FIG. 8. However, this feature of the present invention does provide a quick and easy means for applying preload force to the shock-absorbing system, if desired. It should also be appreciated that although hook and loop components are utilized in conjunction with this particular embodiment of the strap-down system made in accordance with the present invention, other suitable strap fastening means could be used in accordance with the present invention. Such components would include snap fasteners and similar mechanical components that are capable of strapping down the arms of the truck suspension system to the underside of the board. However, hook and loop components provide a preferred system for quickly and easily changing the shock-absorbing system of the present invention. Additionally, it should be appreciated that hook components and loop components attached to the various portions of the skateboard are interchangeable, that is, the loop strap 42 could be a hook strap rather than a loop strap.

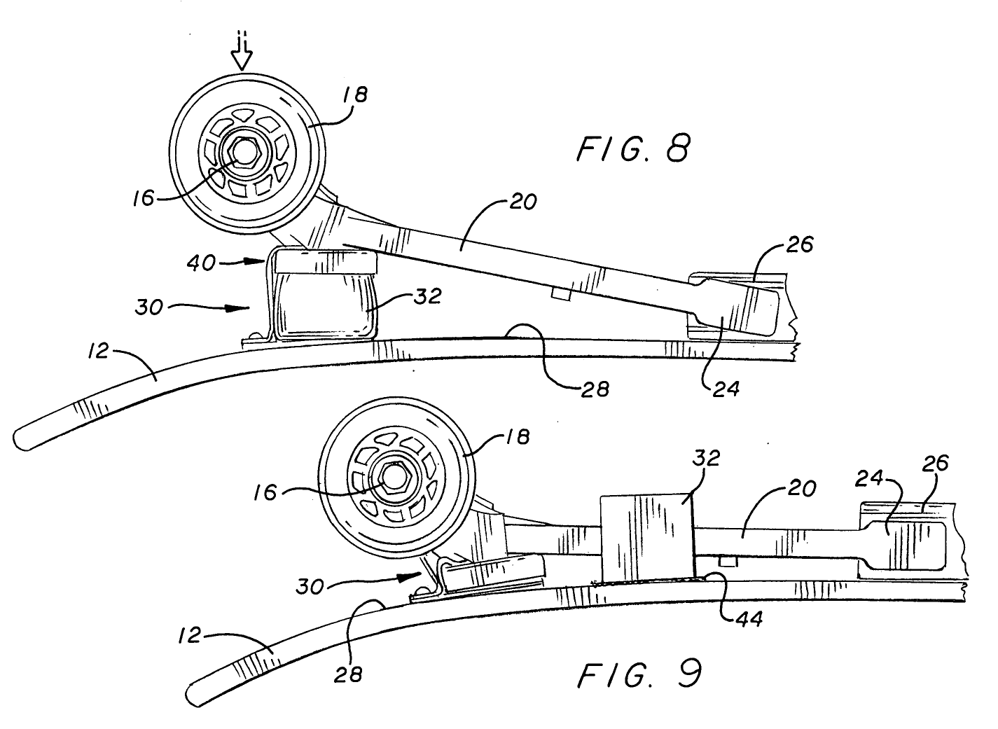

Referring now to FIG. 9, the strap-down system 40 is shown maintaining the A-shaped arm 20 in a stored position when not in use. In this regard, the shock-absorbing system 30, namely the outer shock member 32 and shock-absorbing insert 36, has been removed from the shock cup 38 and placed on a hook strap 44 affixed to the underside 28 of the board 12. As a result of removing the shock-absorbing system 30, the A-shaped arm 20 can be moved closer to the board 12 resulting in a reduced profile. Again, the strap-down system 40 helps maintain the arm 20 in close proximity to the underside 28 of the board 12. This collapsed profile allows the skateboard to be stored in small confines when not in use.

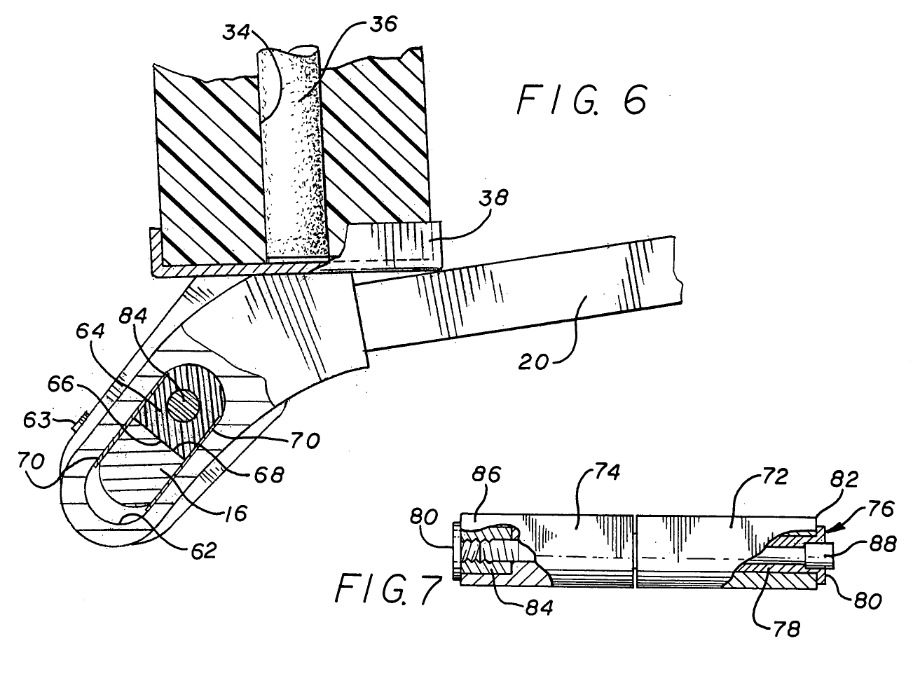

Referring now to FIGS. 6 and 7, the steering control system 60 of the present invention is illustrated. In FIG. 6, the axle housing 22 is shown in cross-section with the wheel axle 16 extending transversely through the elongated opening 62 formed therein. As is shown in FIG. 6, the portion of the wheel axle 16 which extends within the opening 62 has a D-shape cross-sectional profile that conforms to the shape of the elongated opening formed on the axle housing. The D-shape axle provides a larger flat bearing surface and improved strength as compared to a round axle design. A pivot pin 63, such as a bolt, can extend into the wheel housing to allow the axle 16 to pivot within the axle housing.

A steering control dampener 64 contacts the portion of the wheel axle positioned within the wheel housing. This steering control dampener 64 is designed to contact the axle 16 to restrict the steering range or pivot arc of the axle 16 in order to make it more precise and controllable. The steering control dampener 64 can be made from a dampening material such as polyurethane, synthetic or natural rubber, plastic or like components. In use, the dampener 64 provides both steering dampening and shock-absorbing capabilities to the truck suspension system 14. The characteristics of the dampener 64 can be varied by either selecting material having different dampening characteristics or by applying compression on the dampener. The application of compression on elements forming the dampener cause the material to bulge outward, thus to more tightly engage the surface of the axle and to further restrict the range of steering motion that the axle 16 can achieve within the axle housing.

Further details of the steering control system 60 are shown in the cross-sectional view of FIG. 6. The steering control dampener 64 includes a substantially planar surface 66 which contacts a substantially planar surface 68 formed on the wheel axle 16. In this regard, as the dampener 64 is compressed, it begins to bulge forward thus more tightly engaging the surface 68 of the axle 16 to restrict the range of steering motion attainable by the axle. The shock-absorbing features of the dampener 64 may be affected as well.

The elongated opening 62 includes a section of bearing tape 70 which is adhesively affixed to the elongated opening 62 to provide a smooth surface for the wheel axle and the steering control dampener 64 as well. For example, this special bearing tape 70 can be made from materials designed for CNC machines. One suitable bearing tape is made by the Roulon Company. This special bearing tape reduces the amount of friction between the moving components and also helps to prevent friction from wearing down the surface of the axle housing 22. It should be appreciated that other bearing tapes or similar components can be utilized in conjunction with the axle housing to decrease the amount of friction between moving parts and to improve the steering characteristics of the system.

Referring now specifically to FIG. 7, one particular embodiment of a steering control dampener 64 made in accordance with the present invention is illustrated. As can be seen in FIG. 7, the dampener 64 includes two separate dampening elements 72 and 74 connected via a fastener assembly 76 used to impart a compressive force to cause the dampening elements 72 and 74 of the dampener 64 to bulge in order to change the steering characteristics for the steering control system. In this particular embodiment of the invention, the dampener 64 has been designed with a pair of dampening elements 72 and 74 which aids in the assembly and disassembly of the components. However, a single dampener element also could be used.

As can be seen in FIG. 7, the fastener assembly 76 includes a first boss 78 having a flanged head which contacts the end 82 of the dampening element 72. A second boss 84 is located at the other end of the dampening element 74 and includes a flanged head 80 which contacts the other end 86 of the dampening element 74. A bolt 88 extending through the first boss 76 and threadedly engaged with the second boss 84 is utilized to change the compressive force on the two dampening elements 72 and 74. As a result, the rider merely has to turn the bolt 88 to either increase or decrease the compressive force imparted by the flanged heads 80 of the first and second boss 78 and 84. This fastener assembly 76 provides a simple, yet effective, means for changing the compressive force on the dampening elements 72 and 74. The increase or decrease of axial compression on these element 72 and 74 also may change the overall shock-absorbing characteristics of the dampener 64 as well. It should be noted that the type of material and the dampening characteristics of the elements 72 and 74 forming the dampener 64 can vary in order to accommodate the rider's weight or the particular steering characteristics while which are desired. In the regard, the dampener 64 can be made from different types of materials in order to achieve the desired dampening and shock-absorbing features on the skateboard.

Referring now to FIG. 5, the arm housing 26 is shown in a cross-sectional view to illustrate the attachment of the base 24 of the A-shaped arms to the underside of the board 12. As can be seen in FIG. 5, the base 24 of the arm 20 is encased by a urethane bushing 90 which provides additional vibration or shock-absorbing characteristics. This bushing 90 fits within an opening formed in the arm housing 26. A shim plate 92 made from hard resilient rubber or like material can be interposed between the housing 26 and the underside 28 of the board 12. Fasteners 50, such as screws or bolts, maintain the housing 26 securely affixed to the board 12. The amount of tightening of these connectors 50 determines the amount of compression exerted on the bushings 90 and thus the tightness with which the bushings 90 grip the base 24 of the arm 20. In this manner, the amount of pivotal movement of the arms can be changed along with the amount of shock-absorbing capability of these components. In this manner, the various components including the plate 92, bushings 90 and housing 26 help to increase the shock-absorbing capabilities of the truck suspension system 14 of the present invention.

As mentioned above, the outer shock member 32 can be made from a closed cell material which provides substantial shock-absorbing capability to the truck suspension system. Such closed cell foam include EVA foam having a hardness of about 15-50 Shore A. Other suitable materials include urethane, neoprene, sanoprene and closed cell foams having a hardness from about 15 to 50 Shore A. Synthetic and natural rubber are alternate materials that can be used to manufacture the outer shock member 32. The shock-absorbing insert 36 can be made from urethanes or polyurethanes having a hardness from about 30 Shore A to 100 A. Other suitable materials for the insert 32 include thermal plastic elastomers and natural and synthetic rubber.

The present invention thus provides an improved truck suspension system having improved shock-absorbing components which provide a smoother, safer and more comfortable ride while providing enhanced steering controllability and precision. The use of a strap-down system in conjunction with the shock insert system provides a quick and easy system for interchanging shock-absorbing components in order to achieve the desired shock-absorbing function and desired “ride feel” for the rider.

Further modifications and improvements additionally made to the present invention disclosed herein without departing from the spirit and scope of the present invention. Accordingly, it is not intended that the invention be limited, except by the appended claims.

What is claimed is:

1. A skateboard assembly, comprising:
a board for supporting a rider;
a truck suspension system mounted to the underside of the board, the truck suspension system including a pair of wheel axles, each wheel axle having a pair of wheels attached thereto; and
a shock-absorbing system associated with the truck suspension system, the shock-absorbing system including an outer shock member having shock-absorbing capability and at least one shock-absorbing insert having shock-absorbing capability, the outer shock member having at least one recess formed therein for receiving the shock-absorbing insert.

2. The skateboard assembly of claim 1, wherein the outer shock member is made from a closed cell foam.

3. The skateboard assembly of claim 1, wherein the outer shock member has a hardness from about 25 to 45 Shore A.

4. The skateboard assembly of claim 1, wherein the shock-absorbing insert is made from a urethane material.

5. The skateboard assembly of claim 1, wherein the shock-absorbing insert is made from a material having a hardness from about 50 to 95 Shore A.

6. The skateboard assembly of claim 1, wherein the outer shock member encases the shock-absorbing insert.

7. The skateboard assembly of claim 1, wherein the outer shock member has different shock-absorbing capabilities than the shock-absorbing insert.

8. A skateboard assembly, comprising:
a board for supporting a rider;
a truck suspension system mounted to the underside of the board, the truck suspension system including a pair of arms, each arm having one end pivotally attached to the board and a free end attached to a wheel axle, each wheel axle having a pair of wheels attached thereto, the free end of each arm including a wheel axle housing for receiving one of the wheel axles; and
a strap-down system for attaching each of the free ends of the arms to the board, the strap-down system including a first strap attached to each free end of the arms and a second strap attached to the board, the first and second straps being attachable to each other for maintaining each free end of each arm coupled to the board.

9. The skateboard assembly of claim 8, wherein the first strap and second strap of the strap-down system are hook and loop components.

10. The skateboard assembly of claim 8, wherein the strap-down system is releasable when the skateboard is subjected to an impact of a certain force.

11. The skateboard assembly of claim 8, further including a shock-absorbing system attached to the free end of each arm and disposed between each free arm and the board, the shock-absorbing system including an outer shock member having shock-absorbing capability and at least one shock-absorbing insert having shock-absorbing capability, the outer shock member having at least one recess formed therein for receiving the shock-absorbing insert.

12. The skateboard assembly of claim 11, wherein the first strap and second strap of the strap-down system are hook and loop components.

13. The skateboard assembly of claim 12, wherein a hook and loop component is located on the outer shock member and another hook and loop component is placed on the underside of the board, the hook and loop components on the outer shock member and the board being attachable to each other to help maintain the free end of each arm coupled to the board.

14. The skateboard assembly of claim 13, wherein the outer shock member is made from a closed cell foam and the shock-absorbing insert is made from a urethane material.

15. A skateboard assembly, comprising:
a board for supporting a rider;
a truck suspension system mounted to the underside of the board, the truck suspension system including a pair of wheel axles, each wheel axle having a pair of wheels, the truck suspension system including a pair of wheel axle housings having an elongated opening for receiving the wheel axles; and
a steering control system associated with each wheel axle housing, the steering control system including a dampener located within the opening of the wheel housing to impart a dampening force on a portion of the wheel axle placed within the wheel axle housing to control the range of motion of the wheel axle within the wheel axle housing.

16. The skateboard assembly of claim 15, wherein each wheel axle is pivotally mounted within the elongated opening of the wheel axle housing, and the dampener includes a mechanism for importing a compressive force on the dampener in order to cause at least a portion of it to bulge in an outward fashion.

17. The skateboard assembly of claim 15, wherein the mechanism for importing a compressive force on the dampener includes a first boss attached to the dampener and a second boss attached an opposite of the dampener, a bolt extending between the first and second boss with the second boss being threadedly engaged with the bolt.

18. A skateboard assembly, comprising:
a board for supporting a rider;
a truck suspension system mounted to the underside of the board, the truck suspension system including a pair of arms, each arm having one end pivotally attached to the board and a free end which is attached to a wheel axle, each wheel axle having a pair of wheels attached thereto, the free end of each arm including a wheel axle housings for receiving a wheel axle;
a strap-down system for attaching each of the free ends of the arms to the board, the strap-down system including a first strap attached to each of the free ends of the arms and a second strap attached to the board, the first and second straps being attachable to each other for maintaining the free end of the arm coupled to the board;
a shock-absorbing system attached to the free end of each arm and disposed between each free arm and the board, the shock-absorbing system including an outer shock member having shock-absorbing capability and at least one shock-absorbing insert having shock-absorbing capability, the outer shock member having at least one recess formed therein for receiving the shock-absorbing insert; and
a steering control system associated with each wheel axle housing, the steering control system including a dampener located within the opening of the wheel housing to impart a dampening force on a portion of the wheel axle placed within the wheel axle housing to control the range of motion of the wheel axle within the wheel axle housing.

19. The skateboard assembly of claim 18, wherein the first strap and second strap of the strap-down system are hook and loop components.

20. The skateboard assembly of claim 19, wherein the outer shock member is made from a closed cell foam and the shock absorbing insert is made from a urethane material.

21. The shock assembly of claim 18, wherein each arm of the truck suspension system has an A-shape.
